(19) United States
(12) Patent Application Publication
(10) Pub. No.: US 2011/0127786 A1
(43) Pub. Date: Jun. 2, 2011

(54) DEVICE FOR GRIPPING AN OBJECT BY TIGHTENING, COMPRISING A MAIN BODY, ARTICULATED JAW HOLDERS, AND ACTUATING MEANS

(75) Inventors: Frédéric SALET, Salledes (FR); Pierre BERTRAND, Brassac-Les-Mines (FR); Bruno GILARD, Brioude (FR)

(73) Assignee: DE-STA-CO FRANCE, Sainte-Florine (FR)

(21) Appl. No.: 12/942,413

(22) Filed: Nov. 9, 2010

(30) Foreign Application Priority Data
Nov. 12, 2009 (FR) 09 57960

(51) Int. Cl. B25J 15/02; B66C 1/42

(52) U.S. Cl. 294/88

(57) ABSTRACT

A clamp-type gripping device for grasping an object by tightening, in particular a food product, including a main body that is suitable for being mounted on a manipulator, movable jaw holders that are suitable for passing, by pivoting, from a first open position, in which the jaws are loosened, to a second closed position, in which said jaws are tightened around the object that is to be grasped, and actuating means, comprising a first piston that is integral with a second piston by means of a screw, whereby the unit can move axially in translation inside the main body and makes it possible to pass the jaw holders from the first position into the second position, and vice versa. The actuating means are arranged completely, and move exclusively, inside the main body, which is hollow.

### CROSS REFERENCE TO RELATED APPLICATION(S)

This application claims the benefit of French Patent Application No. 0957960, filed Nov. 12, 2009, the disclosure of which is incorporated herein in its entirety by reference.

### BACKGROUND OF THE INVENTION

1. Field of the Invention

This invention relates to a clamp-type gripping device for grasping an object by tightening, in particular a food product.

2. Description of Related Art

It is common, in particular in the field of the farm produce industry, to use clamps of this type to grasp items of food for the purpose of moving them, for example, for transporting them, positioning them in a container, or making them undergo different operations.

In this particular field, hygiene is essential for not contaminating food, and there are very strict standards. Actually, a mechanism that comes into contact with food should not contaminate the latter:
either by the materials that compose it and/or optionally the coatings of said materials, which implies that the materials and the optional treatments are within the standards;
or by a working fluid or lubricants, which involves a total sealing and lubricants in accordance with the standards;
or by detachment of foreign bodies, which involves a minimum of mechanical parts that can become detached;
or by the accumulation and the retention of stains, which involves reducing the metal contact zones under consideration as not being sealed against bacteria.

Furthermore, the mechanism should be washed frequently and disinfected at high pressure and with chemical products that can be corrosive or dangerous for the food item. The clamp is therefore to be designed to not be damaged by this washing/disinfection and to not exhibit zones that are inaccessible to these operations.

One object of this invention is therefore to propose a clamp that optimally meets all of these requirements and that is simple to manufacture as much from an internal standpoint as from an external standpoint, reliable, and easy to use.

### SUMMARY OF THE INVENTION

Thus, this invention has as its object a clamp-type gripping device for grasping an object by tightening, in particular a food product, comprising:
a main body that is suitable for being mounted at the end of a manipulator, such as a gantry or a robotic arm,
movable jaw holders that are suitable for passing, by pivoting, from a first open position, in which the jaws are loosened, to a second closed position, in which the jaws are tightened around the object that is to be grasped, and actuating means, comprising a first piston that is integral with a second piston by means of a screw, whereby the unit can move axially in translation inside the main body under the action of the pressure exerted by a compression fluid that is contained in an intake chamber of the body and that makes it possible to pass the jaw holders from the first position into the second position and, conversely, by means of two locally hollow levers respectively integral with each of the jaw holders and equipped with a projection that is suitable for being inserted into a lateral housing of the second piston, each combined lever/jaw holder unit being articulated on an axis that is perpendicular to the axis of linear movement of the second piston, whereby the translational movement of the second piston causes the rotation of each lever/jaw holder unit at the same time around their respective pivoting axes,
   characterized in that the actuating means are arranged completely, and move exclusively, inside the main body, which is hollow.

According to preferred embodiments, the unit according to this invention comprises at least one of the following characteristics:
The main body is created only in two parts, an upper body and a lower body that are airtight relative to one another and that have no zones for retention of stains and/or zones for retention of fluid such as water or cleaning products;
the attachment means between the upper and lower bodies, just like the means for attachment, centering, and orientation of the device relative to the manipulator, as well as the intakes of compression fluid, are all clustered on a surface of the lower body and are protected from stains by a flat sealing joint;
each jaw holder, formed by a single part, comprises a pivoting rod that is extended by a jaw holder head equipped with a flat contact surface with a tightening jaw;
each pivoting rod has a cylindrical cross section and comprises a free end that is milled longitudinally over half of its diameter in such a way that two complementary coaxial jaw holders fit together at the respective milled end of each of the two pivoting rods;
the milled ends of the pivoting rods of a pair of complementary coaxial jaw holders are held relative to one another by the lever through which they pass;
each hollow portion of the lever comprises a flat inside surface that works in an adjusted manner with a flat surface that is made on the milled free end of each pivoting rod, perpendicular to the longitudinal milling, to make integral and to orient the lever angularly relative to the pair of complementary coaxial jaw holders;
the lever has a “C”-shaped hollow portion that is closed by a fine tightening slot that imparts elasticity to said lever and comprises a bore that is made in the two “C” branches to accommodate a screw that passes through semi-cylindrical indentations made in the milled parts of each pivoting rod, whereby said indentations are coaxial and form a cylindrical opening once the two jaw holders of the same pair are connected to one another;
the contact zones between the upper and lower bodies and/or between the flat surface of the support head and a jaw and/or between the lower body and the manipulator are all of the metal-on-metal type and are protected from stains respectively by the flat joints; and
each lever/jaw holder pair unit is wedged axially on two opposite parallel surfaces of the lever by collars of two collar bearings inserted in a corresponding housing of a portion of the main body and pivots in said bearings.

### BRIEF DESCRIPTION OF THE DRAWINGS

The invention will now be described in more detail with reference to particular embodiments provided only by way of illustration and shown in the accompanying figures in which:

FIG. 1 is a perspective view of a food clamp according to this invention comprising a main body, articulated jaw holders, and a first type of jaw;

FIG. 2 is a perspective view that is similar to FIG. 1, taken from another angle and in which the clamp's jaws have been removed;

FIG. 3 is a perspective bottom view of FIG. 2;

FIG. 4 is a top cutaway view of FIGS. 1 to 3;

FIG. 5 is an exploded perspective view of the body of the clamp;

FIG. 6 is a cutaway view of FIG. 1, whereby the jaw holders are loosened in a first end position;

FIG. 7 is a view that is similar to FIG. 6, but in which the jaw holders are tightened in a second end position;

FIG. 8 is a detail view of FIGS. 6 and 7;

FIG. 9 is an exploded perspective view of the jaw holders of FIGS. 1 to 8;

FIG. 10 is a cutaway detail view of the main body and a jaw holder;

FIG. 11 is a detail cutaway view of the main body;

FIG. 12 is a perspective view of a variant embodiment of FIG. 1, with another type of jaw;

FIG. 13 is a perspective view that is similar to FIG. 12, taken from another angle and in which the clamp's jaws have been removed;

FIG. 14 is a perspective bottom view of FIG. 12; and

FIG. 15 is an exploded perspective view of the jaw holders of FIGS. 12 to 14.

### DETAILED DESCRIPTION OF THE INVENTION

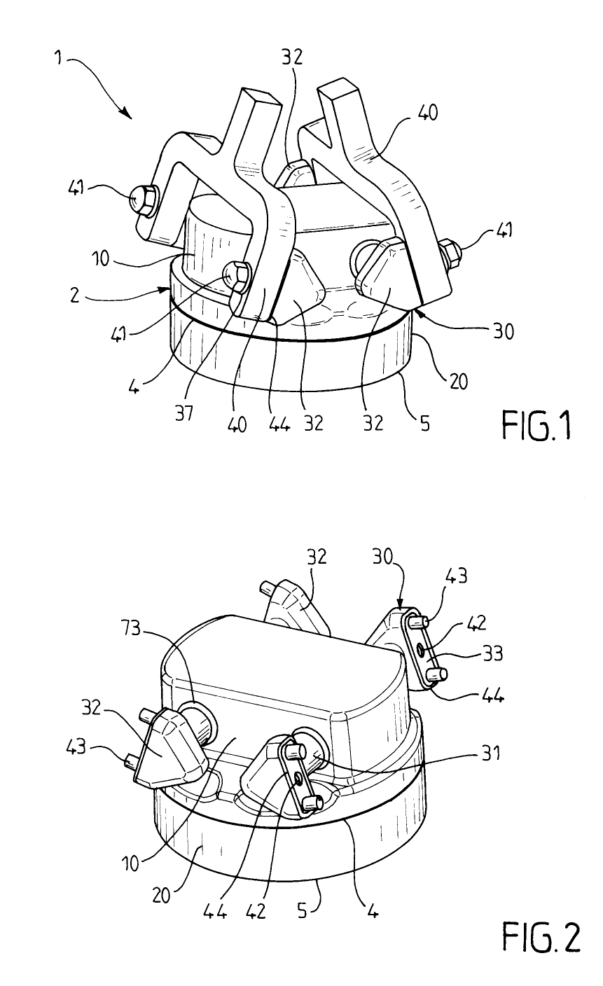

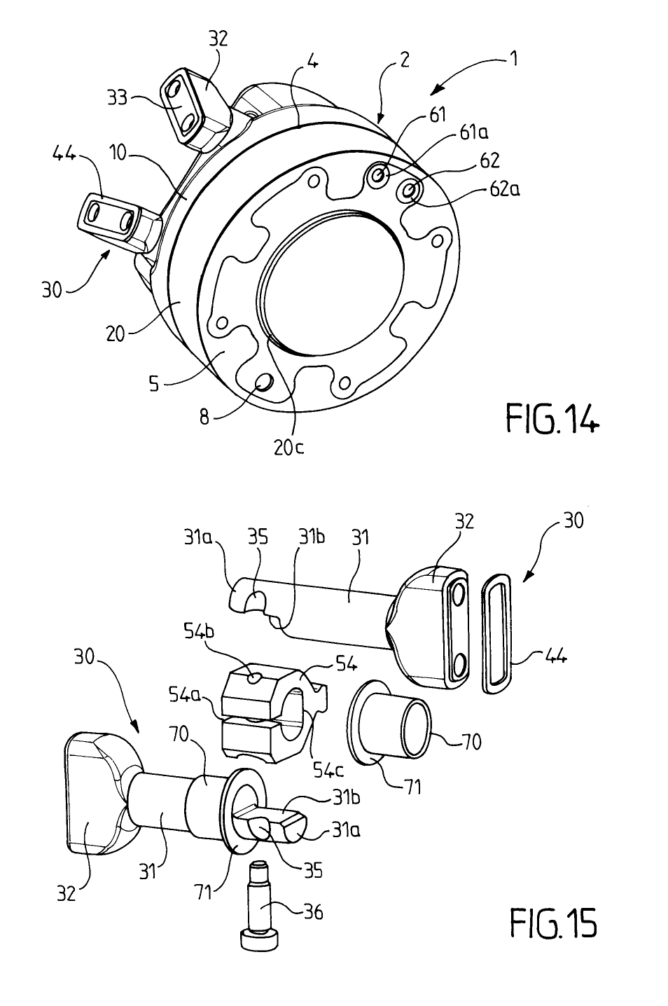

A clamp 1 for food items according to this invention is shown in FIGS. 1 to 15.

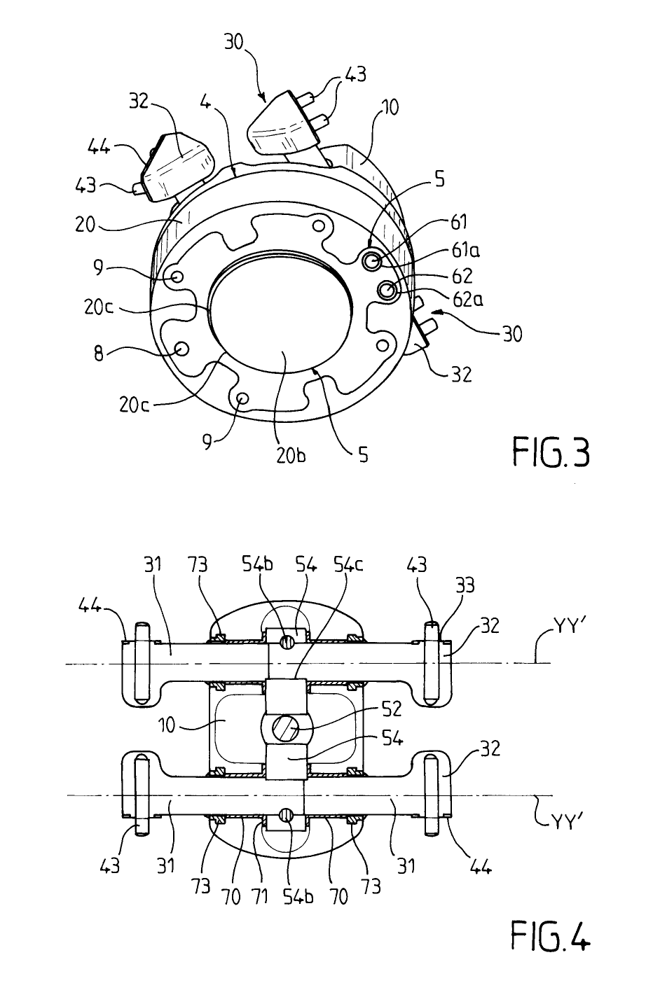

According to a first embodiment that is illustrated by FIGS. 1 to 11, the clamp 1 comprises a main body 2 that is produced in only two parts: an upper body 10 and a lower body 20, oriented angularly by a pin 7. This main body 2 is airtight and suitable for being mounted on a motorized manipulator, for example, at the end of a robotic arm or on a movable gantry, using tappings 9 provided in the lower body 20. The centering of the clamp 1 on the manipulator is also possible by means of a bent central part 20c of the lower surface 20b, and a base 8 for the orientation of the clamp 1 is also provided in the lower body 20 (see FIGS. 3 and 5).

The upper body 10 and the lower body 20 of the main body 2, both having no zones for retention of fluid (oil, water, cleaning product) and of stains, are attached to one another using screws 3 that are distributed, for example, along a circle on a lower surface 20b of the lower body 20.

As can be seen in FIG. 5, a flat sealing joint 4 is placed between the bodies 10 and 20, more specifically between an upper surface 20a of the lower body 20 and a lower surface 10b of the upper body 10. Another flat sealing joint 5 is also placed under the lower surface 20b of the lower body 20 for the connection of the clamp 1 with the manipulator. This seal 5 covers the screws 3 and the openings made in the lower body 20 in an airtight manner to accommodate them.

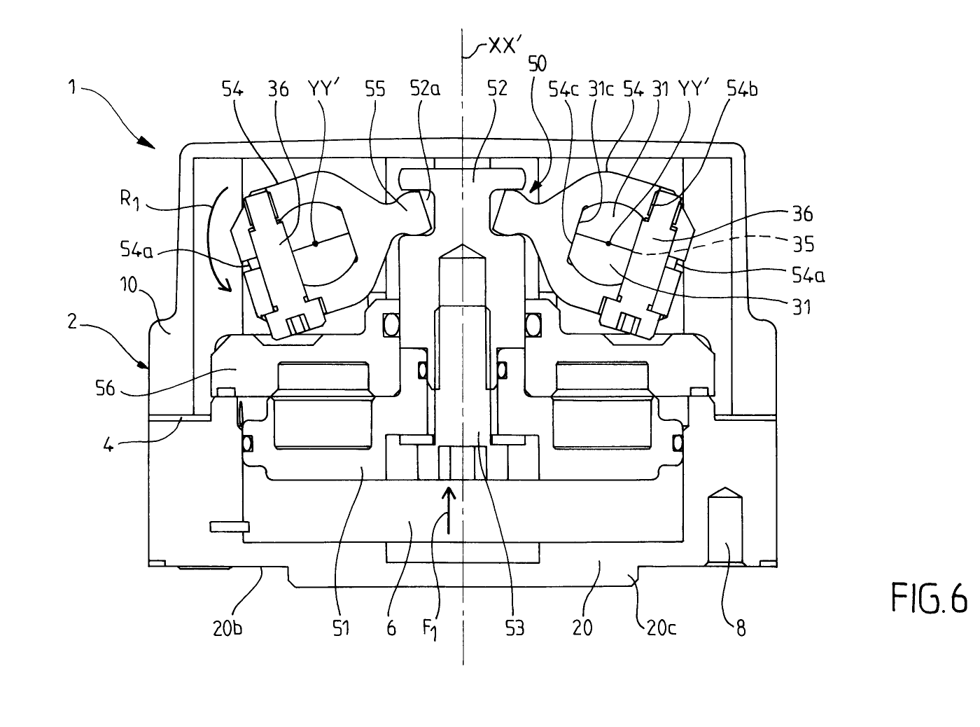

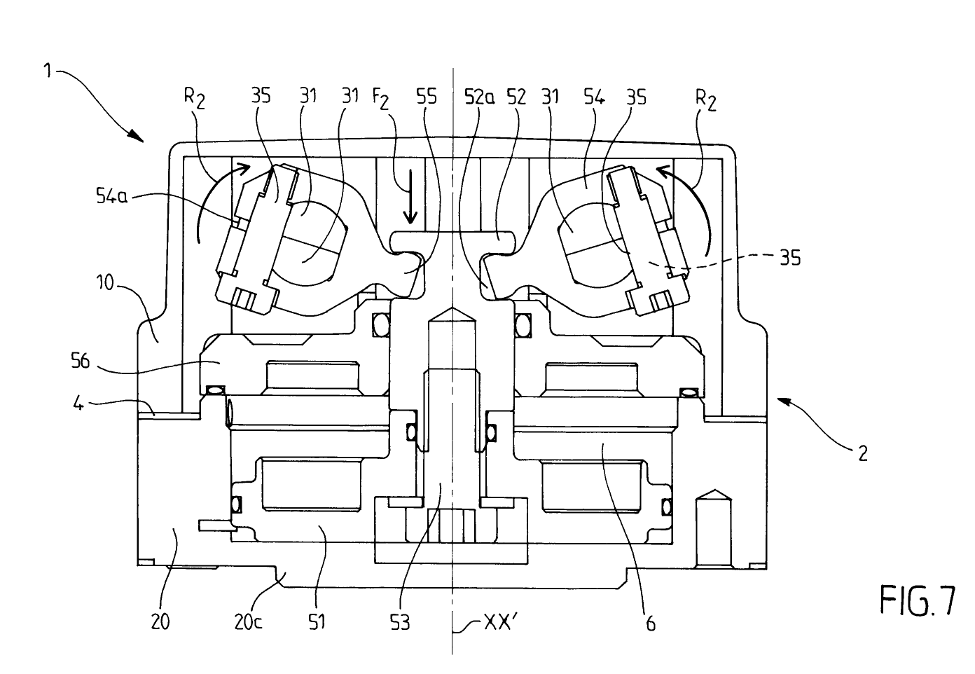

The clamp 1 also comprises movable jaw holders 30 that are suitable for passing, by pivoting, from a first open end position, in which the jaws 40 are loosened (FIG. 6), to a second closed end position, in which said jaws 40 are tightened around the object to be grasped (FIG. 7).

The tightening jaws 40, designed to grasp the food product, are attached to the jaw holders 30 using a screw 41 that has a head joint 37 and works with a tapped opening 42 of each jaw holder 30, and centering pins 43 that are arranged on each side of said tapped opening 42. Thus, the clamp 1 comprises two pairs of articulated jaw holders 30, each pair bearing a jaw 40.

The main body 2 of the clamp 1 contains actuating means 50 for the movement of the jaw holders 30 between the two end positions.

More specifically, these actuating means 50 are arranged completely, and move exclusively, inside the main body 2, which is hollow.

As can be seen in detail in particular in FIGS. 6 and 7, the actuating means 50 comprise a first piston 51 that is integral with a second piston 52 by means of a screw 53. This unit is axially movable in translation (axis XX′) in an airtight manner inside the main body 2 under the action of the pressure exerted by a compression fluid contained in an intake chamber 6 of the lower body 20 of the body 2, and makes it possible to pass the jaw holders 30 from the first position (FIG. 6) to the second position (FIG. 7), and vice versa. An intermediate inside washer 56, shown in particular in FIG. 5, is wedged between the two bodies 10 and 20 and serves to close the intake chamber 6 by creating sealing that is both on the lower body 20 and on the second piston 52.

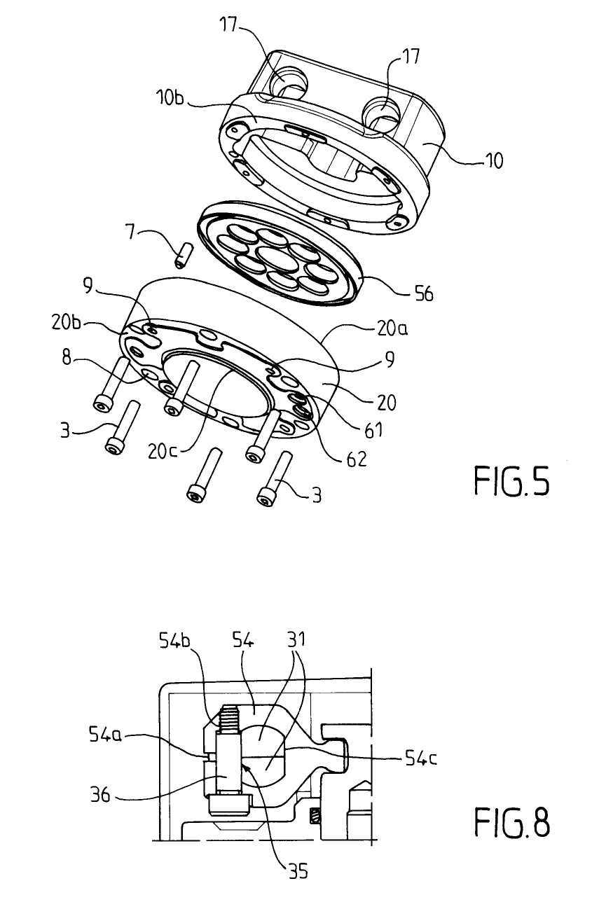

For this purpose, the actuating means 50 also comprise, as can be seen in particular in FIGS. 6 to 8, two locally hollow levers 54 that are integral respectively with each of the jaw holders 30 and are equipped with a projection 55 that is suitable for being inserted into a lateral housing 52a of the second piston 52, whereby each combined lever 54/jaw holder 30 unit is articulated on a YY′ axis that is perpendicular to the XX′ axis of linear movement of the second piston 52 (see FIG. 4).

Thus, as is illustrated by FIGS. 6 and 7, the translational movement of the second piston 52 along the XX′ axis (arrow F1 or F2), caused by the translational movement of the first piston 51 that is integral with it, drives the rotation of each lever 54/jaw holder 30 unit (arrows R1 or R2) at the same time around their respective longitudinal pivoting YY′ axes because of the cooperation between the projection 55 and the housing 52a. This makes it possible to tighten or loosen the jaws 40 around the food to be grasped/released.

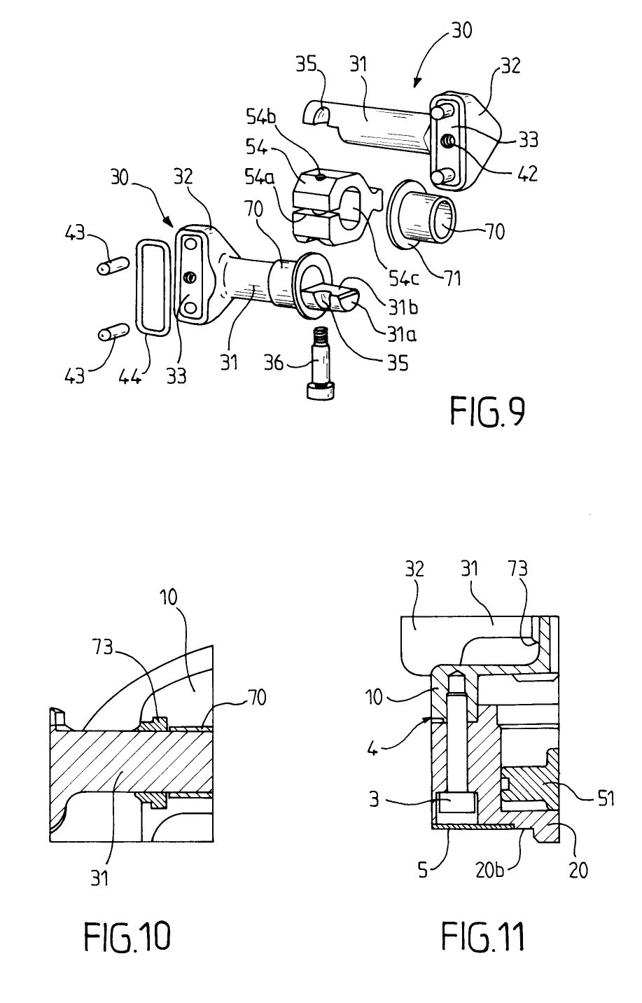

As FIG. 9 illustrates, each jaw holder 30, formed by a single part, comprises a pivoting rod 31 that is extended by a jaw holder head 32 that is equipped with a flat contact surface 33 with a tightening jaw 40 on which rests a flat oval sealing joint 44.

Each pivoting rod 31 has a cylindrical cross section and comprises a free end 31a that is equipped with a longitudinal milling 31b over half of its diameter in such a way that two complementary coaxial jaw holders 30 fit together at the respective milled end 31a of each of the two pivoting rods 31, which are then in the exact extension of one another (see FIG. 4).

The milled ends 31a of the pivoting rods 31 of a pair of complementary coaxial jaw holders 30 are held relative to one another by the lever 54 through which they pass.

For this purpose, as is illustrated by the exploded perspective view of FIG. 9, the lever 54 has a closed “C” shape with a fine tightening slot 54a that imparts an elasticity to said lever and comprises a bore 54b that is made in the two “C” branches to accommodate a screw 36 that passes through semi-cylindrical indentations 35 made in the milled parts 31b of each pivoting rod 31, whereby said indentations 35 are coaxial once the two jaw holders 30 of the same pair are connected to one another.

Each lever 54/jaw holder pair 30 unit is also wedged axially on two opposite parallel surfaces of the lever 54 by collars 71 that are part of two bearings 70 that are inserted in a corresponding housing 17 of the upper body 10 of the main body 2 (see FIG. 5) and pivots in said bearings 70. Lipped scraper joints 73 also make it possible to ensure sealing between the rods 31 and the openings 17 of the upper body 10, whereby these joints are wedged in the housing 17 of the body 10.

Each hollow portion of one of the levers 54 comprises a flat inside surface 54c that works in an adjusted manner with a flat surface 31c made on the milled freed end 31a of each pivoting rod 31, whereby said flat surface is arranged perpendicularly to the longitudinal milling 31b. This makes it possible to make the lever 54 integral and to orient it angularly relative to the pair of complementary coaxial jaw holders 30.

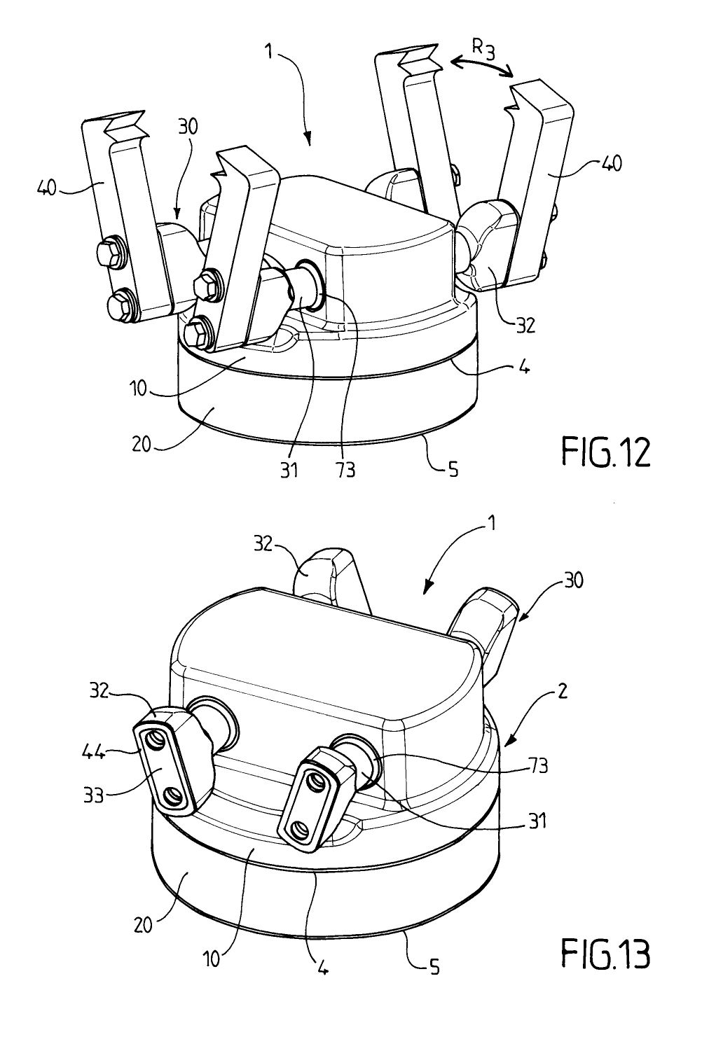

According to the embodiment that is illustrated by FIGS. 12 to 15, the clamp 1 comprises jaws 40 of another type mounted on jaw holders 30 whose surface 33 of the head 32 is oriented differently. Actually, in FIGS. 1 to 13, the surfaces 33 are “back to back” and perpendicular to the longitudinal axis of rotation YY′ of the rods 31, while in FIGS. 13 to 16, the surfaces 33 are in the axial extension of these rods and are all parallel to one another (in the same pair of jaw holders 30 and from one pair to the next).

The operation of this clamp 1 is identical. The translational movement of the pistons 51 and 52 causes the rotation of the levers and therefore the jaw holders 30 to tighten or loosen the jaws 40.

It is also advantageous to note that the different contact zones between the upper body 10 and the lower body 20, between the flat surface 33 of the head 32 of the jaw holder 30 and a jaw 40, and between the lower body 20 and the manipulator are all of the metal-on-metal type and are protected from stains respectively by the flat joints 4, 44, and 5.

As can be seen in FIGS. 3, 5, 11, and 14, the attachment screws 3 between the upper body 10 and the lower body 20, just like the means 8 and 9 for attachment, centering, and orientation of the device relative to the manipulator, as well as compression-fluid intake/outlet 61 and 62 and their associated O-ring sealing joints 61a and 62a, are clustered on the lower surface 20b of the lower body 20 and are protected from stains by a flat sealing joint 5.

It goes without saying that the detailed description of the object of the invention, provided only by way of illustration, in no way constitutes a limitation, the technical equivalents also being included in the field of this invention.

Thus, the shape of the jaws 40 can differ just like that of the jaw holders 30.

Safety springs can be added, for example, within the fluid intake chamber 6. These springs make it possible to ensure that the parts are held between the tightened jaws in the event the supply of pressurized fluid is cut off and also to increase the tightening forces upon closing. It is therefore possible to add a spring for the opening and/or for the closing.

Means for detecting the travel of the pistons 51 and 52 can also be incorporated in the main body 2, for example, in the intake chamber 6. Thus, an analog-output linear potentiometer, totally integrated, can be added, for example, by placing the stationary body of the sensor in the lower body 20, whereby the rod of said sensor is driven by the piston 52 and the outlets are made airtight according to farm produce standards.

1-10. (canceled)

11. A clamp-type gripping device for grasping an object by tightening, in particular a food product, comprising:
a main body configured to be mounted at the end of a manipulator;
movable jaw holders configured to change, by pivoting, from a first open position, in which jaws held by the jaw holders are loosened, to a second closed position, in which the jaws are tightened around the object that is to be grasped, and
actuating mechanism, comprising a first piston that is integral with a second piston by means of a screw, whereby the actuating mechanism can move axially in translation inside the main body under the action of pressure exerted by a compression fluid that is contained in an intake chamber of the main body and that makes it possible to change the jaw holders from the first position into the second position, and said actuating mechanism further comprising two levers that are respectively integral with each of the jaw holders and equipped with a projection configured to be inserted into a lateral housing of the second piston, each combined lever/jaw holder unit being rotatable on an axis that is perpendicular to the axis of linear movement of the pistons, whereby the translational movement of the second piston causes the rotation of each lever/jaw holder unit at the same time around their respective pivoting axes,
wherein the actuating mechanism is arranged completely, and moves exclusively, inside the main body, which is hollow.

12. The device according to claim 11, wherein the main body is made of only two parts, an upper body and a lower body that are airtight relative to one another and that have no zones for retention of stains and/or of fluid.

13. The device according to claim 11, further comprising attachment means between the upper body and the lower body, means for attachment, centering, and orientation of the device relative to the manipulator, as well as a compression-fluid intake/outlet, all being clustered on a lower surface of the lower body and protected from stains by a flat sealing joint.

14. The device according to claim 11, wherein each jaw holder, formed by a single part, comprises a pivoting rod that is extended by a head of the jaw holder that is equipped with a flat contact surface with a tightening jaw.

15. The device according to claim 14, wherein each pivoting rod has a cylindrical section and comprises a free end that is equipped with a longitudinal milling over half its diameter in such a way that two complementary coaxial jaw holders fit together at the respective milled end of each of the two pivoting rods.

16. The device according to claim 15, wherein the milled ends of the pivoting rods of a pair of complementary coaxial jaw holders are held relative to one another by the lever through which they pass.

17. The device according to claim 16, wherein each hollow portion of the lever comprises a flat inside surface that works in an adjusted manner with a flat surface that is made on the milled free end of each pivoting rod, perpendicular to the longitudinal milling, to make integral and to orient the lever angularly relative to the pair of complementary coaxial jaw holders.

18. The device according to claim 17, wherein the lever has a “C”-shaped hollow portion that is closed by a fine tightening slot that imparts elasticity to said lever and comprises a bore that is made in the two “C” branches to accommodate a screw that passes through semi-cylindrical indentations made in the milled ends of each pivoting rod, whereby said indentations are coaxial [and form a cylindrical opening] once the two jaw holders of the same pair are connected to one another.

19. The device according claim 14, wherein the contact zones between the upper body and the lower body and/or between the flat surface of the support head and a jaw, and/or between the lower body and the manipulator are all of the metal-on-metal type and are protected from stains respectively by flat joints.

20. The device according to claim 11, wherein each lever/jaw holder pair unit is wedged axially on two opposite parallel surfaces of the lever by collars of two collar bearings inserted in a corresponding housing of a portion of the main body and pivots in said bearings.
